(19) United States
(12) Patent Application Publication
(10) Pub. No.: US 2012/0177982 A1
(43) Pub. Date: Jul. 12, 2012

(54) SECONDARY BATTERY

(75) Inventor: In-Seop Byun, Yongin-si (KR)

(73) Assignee: Samsung SDI Co., Ltd., Yongin-si (KR)

(21) Appl. No.: 13/239,295

(22) Filed: Sep. 21, 2011

Related U.S. Application Data
(60) Provisional application No. 61/430,893, filed on Jan. 7, 2011.

(51) Int. Cl. H01M 4/64; H01M 2/14; H01M 4/04; H01M 2/02

(52) U.S. Cl. 429/163; 429/211; 29/623.1

(57) ABSTRACT

An electrode assembly for a secondary battery having a positive and negative electrode plates with a separator interposed therebetween. The positive and negative electrode plates have coated and uncoated portions. The length of the interconnection between the coated and uncoated portion of the positive electrode plate is greater than the length of the interconnection between the coated and uncoated portions of the negative electrode plate to reduce heat concentration occurring at the positive electrode plate. In one implementation, that relative lengths between the boundary intervals between the coated and uncoated portions of the positive and negative electrodes are determined using a ratio comprised of the product of the relative resistances and thicknesses.

### RELATED APPLICATION

This application claims the benefit of U.S. Provisional Patent Application No. 61/430,893 filed Jan. 7, 2011, which is hereby incorporated by reference in its entirety herein.

### BACKGROUND OF THE INVENTION

1. Field of the Invention

One or more embodiments of the present invention relate to a secondary battery, and more particularly, to a structure of a secondary battery.

2. Description of Related Art

Recently, compact and light portable electric/electronic devices such as cellular phones, notebook computers, and camcorders have been actively developed and produced. Thus, a portable electric/electronic device includes a battery pack so as to be able to operate in any place without a separate power source. The battery pack includes a rechargeable secondary battery, in consideration of economical aspects. Examples of a representative secondary battery are a nickel-cadmium (Ni—Cd) battery, a nickel-hydrogen (Ni-MH) battery, a lithium (Li) battery, and a lithium (Li)-ion battery. In particular, the Li-ion battery has an operating voltage that is about three times higher than those of the Ni—Cd battery and the Ni-MH battery, which have been widely used as power sources of portable electronic devices. In addition, the Li-ion battery has been widely used due to having a high energy density per specific weight. A secondary battery uses a Li-based oxide as a positive active material, and uses a carbon material as a negative active material.

### SUMMARY OF THE INVENTION

One or more embodiments of the present invention include a secondary battery.

According to one or more embodiments of the present invention, the aforementioned needs are satisfied by an electrode assembly comprising a first electrode plate having a first uncoated portion and a first coated portion that is coated with a first electrode material and a second electrode plate having a second uncoated portion and a second coated portion that is coated with a second electrode material. In this embodiment, the invention further includes a separator interposed between the first electrode plate and the second electrode plate; wherein a first length between the first uncoated portion and the first coated portion is greater than a second length between the second uncoated portion and the second coated portion.

In another embodiment of the present invention, the aforementioned needs are satisfied by a method of fabricating an electrode assembly for a rechargeable battery, the method comprising forming a first electrode plate having a first uncoated portion and a first coated portion that is coated with a first electrode material, forming a second electrode plate having a second uncoated portion and a second coated portion that is coated with a second electrode material. In this embodiment, the invention further comprises sizing the length of the boundary interval between the uncoated portion and the coated portion of the first electrode plate and the length of the boundary interval between the uncoated portion and the coated portion of the second electrode plate based upon the heat produced by the current flow through the boundary intervals in the first and second electrode plates so that the heat produced by the flow of current through the first boundary interval is reduced as a result of increasing the length of the first boundary interval. In this embodiment, the invention further comprises assembling the first electrode plate with the second electrode plate with a separator interposed therebetween.

In yet another embodiment the aforementioned needs are satisfied by a battery assembly comprising a first electrode plate having a first uncoated portion and a first coated portion that is coated with a first electrode material, and a second electrode plate having a second uncoated portion and a second coated portion that is coated with a second electrode material. In this embodiment the invention further comprises a separator interposed between the first electrode plate and the second electrode plate; wherein a first length between the first uncoated portion and the first coated portion is greater than a second length between the second uncoated portion and the second coated portion. In this embodiment, the invention comprises a case that receives the first electrode plate, the second electrode plate and the separator.

### BRIEF DESCRIPTION OF THE DRAWINGS

FIG. 1 is an exploded perspective view of a lithium ion polymer battery, according to an embodiment of the present invention;

FIG. 2 is an exploded perspective view of an electrode assembly of FIG. 1;

FIG. 3 is an image showing a temperature distribution of a positive electrode plate after discharge has ended, according to an embodiment of the present invention;

FIG. 4A is an enlarged perspective view of a portion ‘IVa’ of FIG. 2;

FIG. 4B is an enlarged perspective view of a portion ‘IVb’ of FIG. 2;

FIG. 5 is a plan view of an electrode assembly viewed from above, according to a modified embodiment of the electrode assembly of FIG. 2; and

FIG. 6 is perspective view of a positive electrode plate, according to an embodiment of the present invention.

### DETAILED DESCRIPTION OF THE INVENTION

Reference will now be made in detail to embodiments, examples of which are illustrated in the accompanying drawings.

One or more embodiments of the present invention include a secondary battery that is configured as any of various types. For example, the secondary battery may be a nickel-cadmium (Ni—Cd) battery, a nickel-hydrogen (Ni-MH) battery, or a lithium (Li) battery. The lithium secondary battery may be, for example, a lithium metal battery using a liquid electrolyte, a lithium ion battery, or a lithium polymer battery using a high-molecular weight solid electrolyte. The lithium polymer battery may be classified as a complete solid-type lithium polymer battery that does not contain an organic electrolyte, or a lithium ion polymer battery 1 that uses a gel-type high-molecular weight electrolyte, according to a type of a high-molecular solid electrolyte. Hereinafter, a structure of a secondary battery will be described in terms of the lithium ion polymer battery 1, but is not limited thereto, and thus secondary batteries of various types may be used.

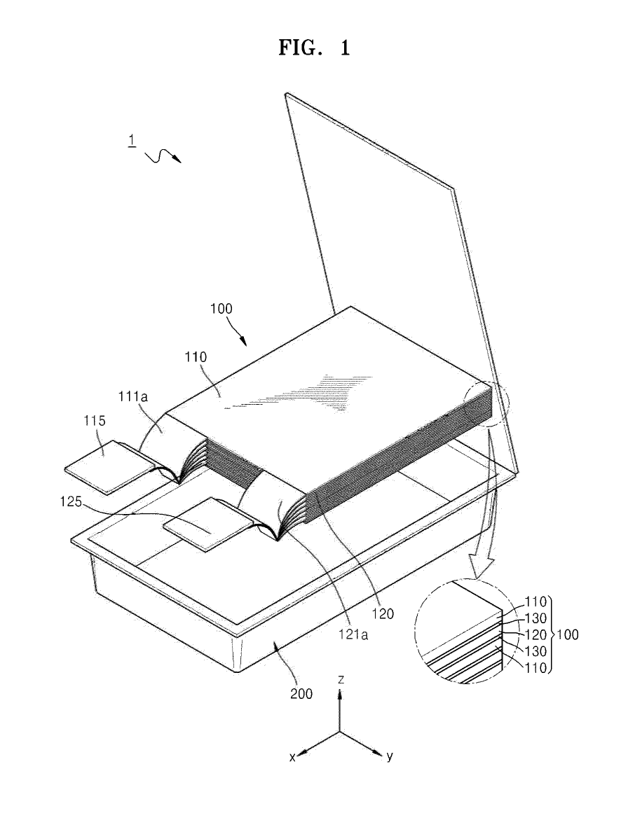

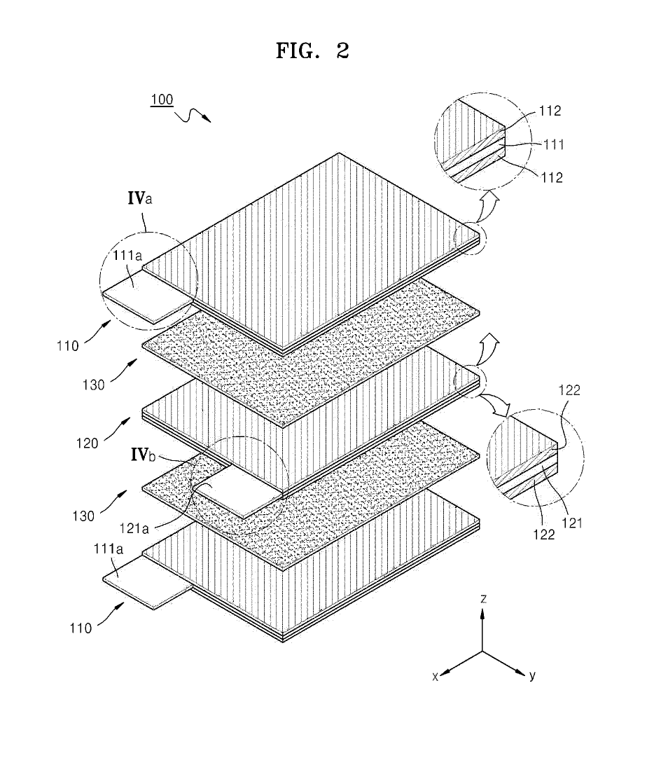

With reference to FIGS. 1 and 2, a structure of the lithium ion polymer battery 1 will be described. FIG. 1 is an exploded perspective view of the lithium ion polymer battery 1, according to an embodiment of the present invention. FIG. 2 is an exploded perspective view of an electrode assembly 100 of FIG. 2. The lithium ion polymer battery 1 may include the electrode assembly 100, a case 200, and an electrolyte (not shown).

The electrode assembly 100 may include a positive electrode plate 110, a negative electrode plate 120, and a separator 130. The electrode assembly 100 may be formed by sequentially stacking the positive electrode plate 110 and the negative electrode plate 120. A separator 130 may be interposed between the positive electrode plate 110 and the negative electrode plate 120. The positive electrode plate 110 may include a positive electrode material 111, a positive electrode non-coated portion 111a, and a positive active material 112. The positive electrode material 111 may include, for example, aluminum (Al). A portion of the positive electrode material 111 may extend to form the positive electrode non-coated portion 111a. The positive active material 112 may include a typical active material. For example, the positive active material 112 may include a lithium cobalt oxide (LiCoO₂), but is not limited thereto. That is, the positive active material 112 may include a silicon-based material, a tin-based material, an aluminum-based material, a germanium-based material, or the like. In this case, the positive active material 112 may include a lithium titanium oxide (LTO), in addition to a typical active material. Referring to FIG. 1, the positive electrode non-coated portion 111a may be connected to a positive electrode lead tap 115 connected to an external terminal of the case 200.

The negative electrode plate 120 may include a negative electrode material 121, a negative electrode non-coated portion 121a, and a negative active material 122. The negative electrode material 121 may include, for example, copper (Cu). A portion of the negative electrode material 121 may extend to form the negative electrode non-coated portion 121a. The negative active material 122 may include a typical active material. For example, the negative active material 122 may include graphite. Referring to FIG. 1, the negative electrode non-coated portion 121a may be connected to a negative electrode lead tap 125 connected to an external terminal of the case 200.

The case 200 may accommodate the electrode assembly 100 and the electrolyte (not shown). The case 200 may be a flexible pouch case.

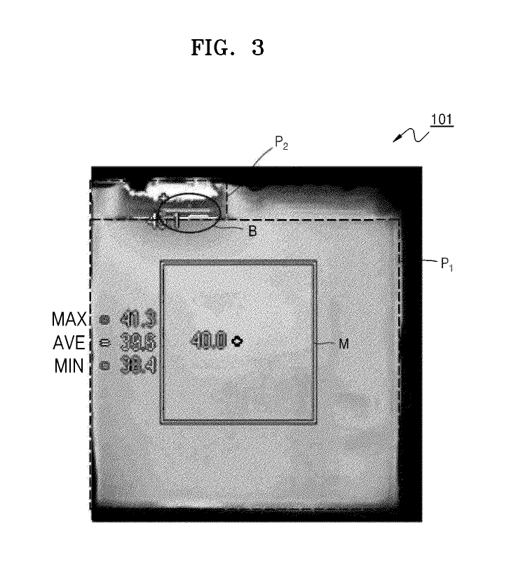

FIG. 3 is an image showing a temperature distribution of a positive electrode plate 101 after discharge has ended, according to an embodiment of the present invention. Referring to FIG. 3, it may be known that temperatures of a first positive electrode plate portion P1 corresponding to the positive active material 112, and a second positive electrode plate portion P2 extending from the first positive electrode plate portion P1, are different. In this case, the reference numerals P1 and P2 may correspond to the reference numerals 111 and 111a of FIG. 2, respectively. With regard to a temperature distribution of a central portion M of the first positive electrode plate portion P1, a minimum temperature is 38.4° C., a maximum temperature is 41.3° C., and an average temperature is 39.6° C., as shown in FIG. 3. A temperature of a point in the central portion M is 40.0° C., as shown in FIG. 3. On the other hand, a temperature of a boundary portion (B) between the first positive electrode plate portion P1 and the second positive electrode plate portion P2 is 45.1° C. That is, the temperature of the boundary portion (B) between the first positive electrode plate portion P1 and the second positive electrode plate portion P2 is higher than points such as those of the central portion M. It may be known that a temperature is increased at a point corresponding to a boundary portion between the positive active material 112 and the positive electrode non-coated portion 111a. A temperature is actively increased in the boundary portion (B) in the positive electrode plates 101 and 110, compared to the negative electrode plate 120. This is because, since a resistance value of the positive active material 112 is generally high, heat is generated at the boundary portion (B) between the positive active material 112 and the positive electrode material 111 due to Joule's heating. The more heat generated between the positive active material 112 and the positive electrode material 111, the higher a current value of C-rate. Such heat intensifies deterioration of a battery as charge/discharge are repeatedly performed, thereby reducing the lifetime and stability of the battery. Thus, it is required to minimize such deterioration.

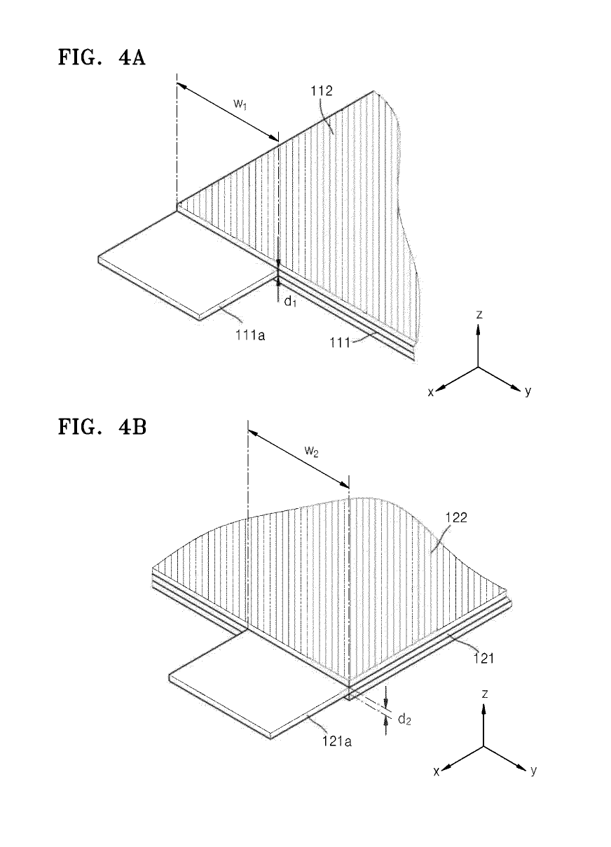

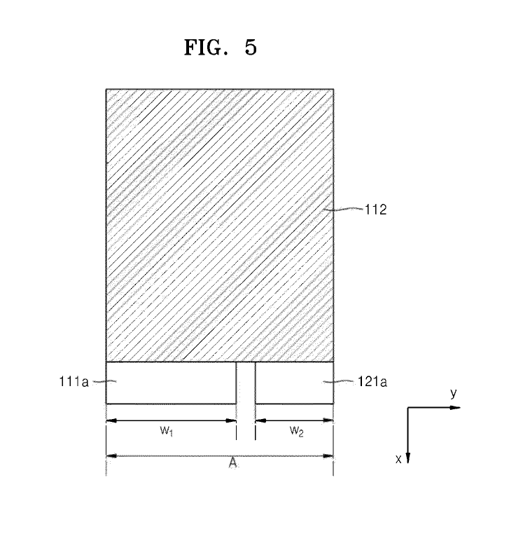

With reference to FIGS. 4A, 4B, and 5, a positive electrode boundary interval w₁ between the positive active material 112 and the positive electrode non-coated portion 111a, and a negative electrode boundary interval w₂ between the negative active material 122 and the negative electrode non-coated portion 121a will be described. FIG. 4A is an enlarged perspective view of a portion ‘IVa’ of FIG. 2. FIG. 4B is an enlarged perspective view of a portion ‘IVb’ of FIG. 2. FIG. 5 is a plan view of an electrode assembly 100 viewed from above, according to a modified embodiment of the electrode assembly 100 of FIG. 2.

Comparing the positive electrode plate 110 and the negative electrode plate 120, since the negative active material 122 of the negative electrode plate 120 uses a material with a low resistance value, such as graphite, a resistance difference between the negative active material 122 and the negative electrode non-coated portion 121a including Cu or the like may not be great, but a resistance difference between the positive active material 112 with a high resistance value and the positive electrode non-coated portion 111a may be great.

In this case, the positive electrode boundary interval w₁ is defined as an interval between the positive active material 112 and the positive electrode non-coated portion 111a, and the negative electrode boundary interval w₂ is defined as an interval between the negative active material 122 and the negative electrode non-coated portion 121a. A current is passed through the positive electrode non-coated portion 111a, the negative electrode non-coated portion 121a, and the like through charge/discharge, and heat is generated between the positive active material 112 and the positive electrode non-coated portion 111a, and between the negative active material 122 and the negative electrode non-coated portion 121a, due to Joule's heating. In this case, the amount heat generated due to Joule's heating is affected by the positive electrode boundary interval w₁ and the negative electrode boundary interval w₂. Thus, the positive electrode boundary interval w₁, which generates a large amount of heat due to having a high resistance value associated therewith, may be wider than the negative electrode boundary interval w₂. In this case, FIG. 5 is a plan view of the electrode assembly 100, in which the positive electrode boundary interval w₁ is wider than the negative electrode boundary interval w₂, viewed from above. The positive electrode boundary interval w₁ and the negative electrode boundary interval w₂ will be described in more detail, with reference to equations.

When a capacity C of each unit electrode plate is obtained by dividing the entire capacity of the lithium ion polymer battery 1 by the number of positive electrode plates 110 and negative electrode plates 120, a current density of unit area of the positive electrode plate 110 or the negative electrode plate 120 may be obtained by dividing the capacity C by a unit area. For example, in FIG. 4A, when a capacity of the positive electrode plate 110 is C, a current density of unit area (mA/mm²) of a boundary portion between the positive active material 112 and the positive electrode non-coated portion 111a may be obtained by C/w₁d₁. Similarly, in FIG. 4B, when a capacity of the negative electrode plate 120 is C, a current density of unit area (mA/mm²) of a boundary portion between the negative active material 122 and the negative electrode non-coated portion 121a may be obtained by C/w₂d₂. In this case, d₁ is a thickness of the positive electrode plate 110, and d₂ is a thickness of the negative electrode plate 120.

In this case, a heat amount Q generated per unit area may be calculated according to Equation 1 below

Q=I²Rt(J) (1)

In Equation 1, I is a current density of unit area (mA/mm²), R is a resistance value (Ω), and t is a period of time (sec). A heat amount Q1 per unit area of the positive electrode plate 110 is

$${( \frac{C}{{w}_{1} {d}_{1}} )}^{2} {R}_{1} t .$$

In this case, R₁ is a resistance value between the positive active material 112 and the positive electrode material 111. A heat amount (Q2) per unit area of the negative electrode plate 120 is

$${( \frac{C}{{w}_{2} {d}_{2}} )}^{2} {R}_{2} t .$$

In this case, R₂ is a resistance value between the negative active material 122 and the negative electrode material 121.

In general, the resistance R₁ between the positive active material 112 and the positive electrode material 111 is greater than the resistance R₂ between the negative active material 122 and the negative electrode material 121. Thus, in boundary portions between the positive active material 112/ the negative active material 122 and the positive electrode non-coated portion 111a/ the negative electrode non-coated portion 121a, the heat amount Q1 per unit area of the positive electrode plate 110 is greater than the heat amount Q2 per unit area of the negative electrode plate 120, and thus the positive electrode plate 110 may deteriorate and thus may be damaged.

In general, a difference between the thickness d₁ of the positive electrode plate 110 and the thickness d₂ of the negative electrode plate 120 is not that great. Since it is not easy to design-change the resistances R₁ and R₂ the positive electrode boundary interval w₁ and the negative electrode boundary interval w₂ may be controlled so that heat generated at a boundary portion of the positive electrode plate 110 may be less than or equal to heat generated at a boundary portion of the negative electrode plate 120.

According to Equations 2 and 3, the positive electrode boundary interval w₁ and the negative electrode boundary interval w₂ may be calculated to be such that the heat amount Q1 per unit area of the positive electrode plate 110 is equal to the heat amount Q2 per unit area of the negative electrode plate 120.

$$\begin{matrix}{( \frac{C}{{w}_{1} {d}_{1}} )}^{2} {R}_{1} t = {( \frac{C}{{w}_{2} {d}_{2}} )}^{2} {R}_{2} t & ( 2 ) \\ {w}_{1} = \sqrt{\frac{{R}_{1}}{{R}_{2}}} \cdot \frac{{d}_{2}}{{d}_{1}} {w}_{2} & ( 3 )\end{matrix}$$

That is, when the heat amount Q1 per unit area of the positive electrode plate 110 is equal to the heat amount Q2 per unit area of the negative electrode plate 120, according to Equation 2, the positive electrode boundary interval w₁ may be expressed using the negative electrode boundary interval w₂ and constants, according to Equation 3.

Thus, when the positive electrode boundary interval w₁ and the negative electrode boundary interval w₂ satisfy Equation 3, heat may be uniformly generated at the boundary portions of the positive electrode plate 110 and the negative electrode plate 120 rather than being generated more at one side.

Hereinafter, the heat amount Q1 per unit area of the positive electrode plate 110 and the heat amount Q2 per unit area of the negative electrode plate 120 according to the positive electrode boundary interval w₁ and the negative electrode boundary interval w₂ will be described. The positive electrode material 111 may include Al, and a resistance value of Al may be about 0.3Ω. A surface resistance value of the positive active material 112 may be about 620Ω. In this case, a resistance value between the positive electrode material 111 and the positive active material 112 may be about 300Ω. A thickness of the positive electrode material 111 may be about 20 μm.

In addition, the negative electrode material 121 may include Cu, and a resistance value of Cu may be about 0.3Ω. A surface resistance value of the negative active material 122 may be about 2.8Ω. A resistance value between the negative electrode material 121 and the negative active material 122 may be about 1.3Ω. A thickness of the negative electrode material 121 may be about 15 μm. In this case, by substituting the values into the constants of Equation 3, the following result may be obtained according to Equation 4.

$${w}_{1} = \sqrt{\frac{300}{1.3}} \cdot \frac{20}{15} {w}_{2} = 11.39 {w}_{2} \qquad ( 4 )$$

That is, when the negative electrode boundary interval w₂ is 8.8% of the positive electrode boundary interval w₁ (w₂/w₁), the heat amount Q1 per unit area of the positive electrode plate 110 may be equal to the heat amount Q2 per unit area of the negative electrode plate 120. Referring to FIG. 5, the sum of the positive electrode boundary interval w₁ and the negative electrode boundary interval w₂ may not be greater than an entire width A of the positive electrode plate 110 and the negative electrode plate 120. If not, the positive electrode non-coated portion 111a may overlap the negative electrode non-coated portion 121a and thus may cause a short circuit. Thus, when the positive electrode non-coated portion 111a and the negative electrode non-coated portion 121a are maximally enlarged, that is, when the sum of the positive electrode boundary interval w₁ and the negative electrode boundary interval w₂ is equal to the width A of the positive electrode plate 110 and the negative electrode plate 120, the positive electrode boundary interval w₁ may be enlarged to a maximum of 92% (11.39/12.39) of the entire width A of the positive electrode plate 110 and the negative electrode plate 120.

If the sum of the positive electrode non-coated portion 111a and the negative electrode non-coated portion 121a is equal to entire width A of the positive electrode plate 110 and the negative electrode plate 120, the positive electrode boundary interval w₁ needs to be equal to or greater than the negative electrode boundary interval w₂, and thus the positive electrode boundary interval w₁ may be 50 to 92% of the entire width A of the positive electrode plate 110 and the negative electrode plate 120.

In addition, as the positive electrode boundary interval w₁ is enlarged, a contact area between the positive electrode lead tap 115 and the positive electrode non-coated portion 111a is further increased, and a resistance value between the positive electrode non-coated portion 111a and the positive electrode lead tap 115 may also be reduced. That is, the positive electrode non-coated portion 111a and the positive electrode lead tap 115 are electrically connected, and thus resistance is present between the positive electrode non-coated portion 111a and the positive electrode lead tap 115. Since a contact area between the positive electrode non-coated portion 111a and the positive electrode lead tap 115 is enlarged, resistance between the positive electrode non-coated portion 111a and the positive electrode lead tap 115 is reduced. Thus, heat generated due to the resistance between the positive electrode non-coated portion 111a and the positive electrode lead tap 115 may be reduced.

The heat amount Q1 per unit area of the positive electrode plate 110 and the heat amount Q2 per unit area of the negative electrode plate 120 are calculated as follows. The electrode assembly 100 may include 42 pairs of positive electrode plates 110 and negative electrode plates 120. In detail, the electrode assembly 100 includes the 42 pairs of positive electrode plates 110 and negative electrode plates 120, wherein a single negative electrode plate 120 and a single positive electrode plate 110 corresponding thereto may constitute each pair, and may further include a negative electrode plate 120 corresponding to the outermost positive electrode 110. That is, the 43 negative electrode plates 120 and the 42 positive electrode plates 110 may be alternatingly disposed. In this case, the number of negative electrode plates 120 and the number of positive electrode plates 110 are just examples, and are not particularly limited.

In this case, an area of the positive electrode plates 110 or the negative electrode plates 120 may be about 540 cm². A current density of the lithium ion polymer battery 1 may be 1.25 mA/cm². A capacity of a single lithium ion polymer battery 1 according to a current capacity per unit weight of an active material of a unit cell may be about 56.98 A. Thus, a capacity per sheet of the positive electrode plate 110 the negative electrode plate 120, obtained by dividing the capacity of the lithium ion polymer battery 1 by 42, may be about 1357 mA.

Table 1 shows a heat amount according to the positive electrode boundary interval w₁. Referring to FIGS. 2 and 4A, when a reference corresponds to a case where an entire width of the positive electrode plate 110 is about 245 mm, and the positive electrode boundary interval w₁ is 90 mm, the heat amount Q1 per unit area of the positive electrode plate 110 is obtained.

TABLE 1

| | | | | | | |
|---|---|---|---|---|---|---|
| Positive electrode boundary | 130% | 120% | 110% | 100% | 90% | 80% |
| interval ratio (%) | | | | | | |
| Positive electrode boundary | 117 | 108 | 99 | 90 | 81 | 72 |
| interval w₁(mm) | | | | | | |
| Positive material boundary | 2.34 | 2.2 | 2.0 | 1.8 | 1.6 | 1.4 |
| sectional area (mm²) | | | | | | |
| Current density per unit | 579.8 | 628.1 | 685.2 | 753.7 | 837.4 | 942.1 |
| area (mA/mm²) | | | | | | |
| Heat amount Q1 per unit | 101 | 118 | 141 | 170 | 210 | 266 |
| area of positive electrode | | | | | | |
| plate (J) | | | | | | |
| Increase and decrease with | 59% | 69% | 83% | 100% | 123% | 156% |
| respect to reference | | | | | | |

In FIG. 1, a sectional area of a positive electrode material boundary is a value obtained by multiplying the positive electrode boundary interval w₁ by the thickness d₁ of the positive electrode material 111. A current density of unit area is a value obtained by dividing a capacity of each sheet of the positive electrode plate 110 of 1357 mA by the sectional area of the positive electrode material boundary. The heat amount Q1 per unit area of the positive electrode plate 110 is obtained by obtaining a value based on Equation 1 and then multiplying the value by 10⁶.

TABLE 2

| | Negative electrode boundary interval ratio (%) | | | | |
|---|---|---|---|---|---|
| | 100% | 90% | 80% | 70% | 60% |
| Negative | 90 | 81 | 72 | 63 | 54 |
| electrode | | | | | |
| boundary | | | | | |
| interval w₂ (mm) | | | | | |
| Negative | 1.35 | 1.215 | 1.08 | 0.945 | 0.81 |
| material | | | | | |
| boundary | | | | | |
| sectional area | | | | | |
| (mm²) | | | | | |
| Current density | 1004.938 | 1116.598 | 1256.481 | 1435.979 | 1675.309 |
| per unit area | | | | | |
| (mA/mm²) | | | | | |
| Heat amount | 1.312871 | 1.620829 | 2.052369 | 2.680646 | 3.648657 |
| Q2 per unit | | | | | |
| area of | | | | | |
| negative | | | | | |
| electrode plate | | | | | |
| (J) | | | | | |
| Increase and | 100% | 123% | 156% | 204% | 278% |
| decrease with | | | | | |
| respect to | | | | | |
| reference | | | | | |

| | Negative electrode boundary interval ratio (%) | | | | | |
|---|---|---|---|---|---|---|
| | 50% | 40% | 30% | 20% | 10% | 8.8% |
| Negative | 45 | 36 | 27 | 18 | 9 | 7.92 |
| electrode | | | | | | |
| boundary | | | | | | |
| interval | | | | | | |
| w₂ (mm) | | | | | | |
| Negative | 0.675 | 0.54 | 0.405 | 0.27 | 0.135 | 0.1188 |
| material | | | | | | |
| boundary | | | | | | |
| sectional | | | | | | |
| area (mm²) | | | | | | |
| Current | 2010.37 | 2512.963 | 3350.62 | 5025.926 | 10051.85 | 11422.56 |
| density | | | | | | |
| per unit | | | | | | |
| area | | | | | | |
| (mA/mm²) | | | | | | |
| Heat | 5.254066 | 8.209478 | 14.5946 | 32.83791 | 131.3516 | 169.53 |
| amount | | | | | | |
| Q2 per | | | | | | |
| unit area | | | | | | |
| of | | | | | | |
| negative | | | | | | |
| electrode | | | | | | |
| plate (J) | | | | | | |
| Increase | 400% | 625% | 1112% | 2501% | 10005% | 12913% |
| and | | | | | | |
| decrease | | | | | | |
| with | | | | | | |
| respect | | | | | | |
| to | | | | | | |
| reference | | | | | | |

Values of Table 2 may be obtained by using a method similar to that of Table 1. In this case, a positive/negative electrode boundary interval ratio (%) refers to a degree of increase and decrease with respect to a reference based on a case where the positive electrode boundary interval w₁ and the negative electrode boundary interval w₂ are each 90 mm. The increase and decrease with respect to the reference refers to increase and decrease in a heat amount based on a case where the positive electrode boundary interval w₁ and the negative electrode boundary interval w₂ are each 90 m m. In this case, the widths of the positive electrode boundary interval w₁ and the negative electrode boundary interval w₂ may be determined in consideration of the sum of the heat amount Q1 per unit area of the positive electrode plate 110 and the heat amount Q2 per unit area of the negative electrode plate 120. For example, when the negative electrode boundary interval w₂ (mm) is 9 mm, the heat amount Q2 (J) per unit area of the negative electrode plate 120 may be about 131 J, and a width of the negative electrode boundary interval w₂ may be determined to be within 99 to 108 mm so that the heat amount Q1 (J) per unit area of the positive electrode plate 110 may be equal to the heat amount Q2 per unit area of the negative electrode plate 120.

Referring to Table 1, when the positive electrode boundary interval ratio is 100%, the heat amount Q1 per unit area of the positive electrode plate 110 is about 170 (J). Referring to Table 2, when the negative electrode boundary interval ratio is 8.8%, the heat amount Q2 per unit area of the negative electrode plate 120 is about 169.53 (J). Likewise, when the heat amount Q1 per unit area of the positive electrode plate 110 is similar to the heat amount Q2 per unit area of the negative electrode plate 120, deterioration of a battery due to non-uniform heat amount may be reduced. If a temperature is partially increased due to a non-uniform heat amount, the lifetime of the battery may be reduced. For example, a solid electrolyte interface (SEI) layer disposed in the battery is a protective layer for facilitating stable charge/discharge of an electrolyte, and may be weak to heat and thus damaged at a temperature of about 60 to about 80° C. Thus, if heat amounts are uniform, the SEI layer and the like may not be damaged due to a non-uniform heat amount, thereby ensuring the stability and lifetime of the battery.

In this case, it is obviously that the combination of the heat amount Q1 per unit area of the positive electrode plate 110 and the heat amount Q2 per unit area of the negative electrode plate 120 has various forms. This is generalized in Equation 5 below.

$$F ( {w}_{1} , {w}_{2} ) = {( \frac{C}{{w}_{1} {d}_{1}} )}^{2} {R}_{1} t + {( \frac{C}{{w}_{2} {d}_{2}} )}^{2} {R}_{2} t \qquad ( 5 )$$

In this case, the positive electrode boundary interval w₁ and the negative electrode boundary interval w₂ for minimizing a function F(w₁,w₂) may be obtained. In another design condition, it is obvious that the positive electrode boundary interval w₁ and the negative electrode boundary interval w₂ may be obtained simultaneously according to another equation. For example, in FIG. 5, when the sum of the positive electrode boundary interval w₁ and the negative electrode boundary interval w₂ is equal to the entire width A of the positive electrode plate 110 and the negative electrode plate 120, Equation 6 is obtained.

w₁+w₂=A (6)

In this case, by combining Equations 5 and 6, the maximum and minimum values of the positive electrode boundary interval w₁ and the negative electrode boundary interval w₂ may be obtained.

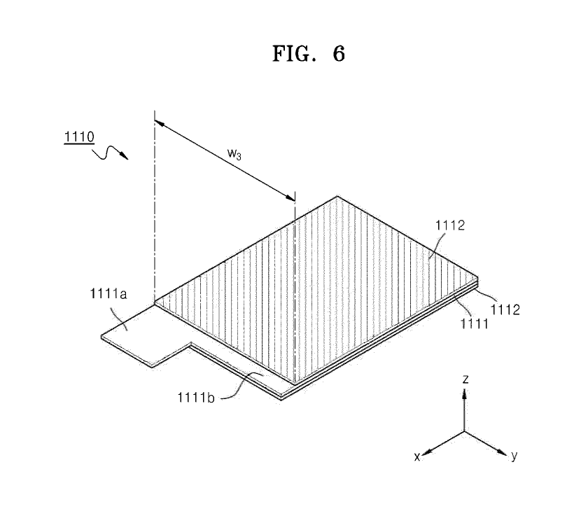

Referring to FIG. 6, a modified example of the positive electrode plate 110 of FIG. 2 will now be described. Referring to FIGS. 2, 4A, 4B, and 5, the positive active material 112 covers the positive electrode material 111, and the positive electrode non-coated portion 111a with a width w₁ that is smaller than an entire width A of the positive electrode material 111 extends from the positive electrode material 111. However, since the heat amount Q1 per unit area of the positive electrode plate 110 is

$${( \frac{C}{{w}_{1} {d}_{1}} )}^{2} {R}_{1} t ,$$

as the positive electrode boundary interval w₁ is increased, the heat amount Q1 per unit area of the positive electrode plate 110 is reduced. Thus, in FIG. 6, in order to increase a positive electrode boundary interval w₃ in a positive electrode plate 1110, the positive electrode boundary interval w₃ may be equal to a width of a positive electrode material 1111. In this case, positive electrode non-coated portions 1111a and 1111b may include a first positive electrode non-coated portion 1111b extending from the positive material 1111 so as to have the same width as that of the positive material 1111, and a second positive electrode non-coated portion 1111a extending from the positive material 1111 so as to have a smaller width than that of the positive material 1111. In this case, the negative electrode non-coated portion 121a has the same structure as in FIG. 2. That is, the electrode assembly 100 may include the positive electrode plate 1110 of FIG. 6, the negative electrode plate 120 of FIG. 2, and the separator 130 interposed therebetween.

Thus, the first positive electrode non-coated portion 1111b of FIG. 6 is the same or similar as the width of the negative electrode non-coated portion 121a of FIG. 2, and the positive electrode boundary interval w₃ of FIG. 6 may be greater than the negative electrode boundary interval w₂ of FIG. 4B.

It should be understood that the exemplary embodiments described therein should be considered in a descriptive sense only and not for purposes of limitation. Descriptions of features or aspects within each embodiment should typically be considered as available for other similar features or aspects in other embodiments. Thus, the scope of the pending application should not be limited to the foregoing description, but should be defined by the appended claims.

What is claimed is:

1. An electrode assembly comprising:
a first electrode plate having a first uncoated portion and a first coated portion that is coated with a first active material;
a second electrode plate having a second uncoated portion and a second coated portion that is coated with a second active material; and
a separator interposed between the first electrode plate and the second electrode plate; wherein a first length between the first uncoated portion and the first coated portion is greater than a second length between the second uncoated portion and the second coated portion.

2. The assembly of claim 1, wherein the first electrode plate comprises a positive electrode plate and the second electrode plate comprises a negative electrode plate and wherein the first length comprises a length on the positive electrode plate and the second length comprises a length on the negative electrode plate.

3. The assembly of claim 1, wherein the first length is selected to be greater than the second length so that the heat produced by the first electrode plate is substantially the same as or less than the heat that is produced by the second electrode plate.

4. The assembly of claim 1, wherein the interval between the coated first active material and the non-coated portion of the first electrode plate comprises a first boundary interval having a width of w1 and wherein the interval between the coated second active material and the non-coated portion of the second electrode plate comprises a second boundary interval having a width of w2.

5. The assembly of claim 4, wherein the length of first boundary interval w1 is equal to or less than
$${w}_{1} = \sqrt{\frac{{R}_{1}}{{R}_{2}}} \cdot \frac{{d}_{2}}{{d}_{1}} {w}_{2}$$
wherein w2 comprises the length of the second boundary interval between the coated and the uncoated portions of the second electrode plate, R1 comprises the resistance of the coated portion of the first electrode plate, R2 comprises the resistance of the coated portion of the second electrode plate, d1 comprises the thickness of the first electrode plate and d2 comprises the thickness of the second electrode plate.

6. The assembly of claim 5, wherein the ratio of w1 to w2 falls within the range of approximately 1 to 11.39.

7. The assembly of claim 1, wherein a first boundary interval between the uncoated portion and the coated portion of the first electrode plate has a first length w1 and a second boundary interval between the uncoated portion material and the coated portion of the second electrode plate has a second length w2 and wherein the coated portions of the first and second electrode plates are aligned so as to be positioned adjacent each other along a line having a common length and wherein the sum of w1 and w2 is less than or equal to the common length.

8. The assembly of claim 7, wherein the amount of the common length that is covered by the first boundary interval having a width w1 is substantially proportional to the product of the ratio of the relative resistances between the first and second boundary intervals and ratio of the relative thicknesses between the first and second boundary intervals.

9. The assembly of claim 7, wherein the width of the uncoated portion of the first electrode plate comprises the width w1 of the first boundary interval and the width of the uncoated portion of the second electrode plate comprises the width of the second boundary interval w2 and wherein the uncoated portions of the first and second electrode plates are coupled to the coated portions so that the uncoated portions do not overlap.

10. The assembly of claim 9, wherein the width w1 of the uncoated portion of the first electrode comprises approximately 50 to 92% of the common length.

11. The assembly of claim 1, wherein the uncoated portions of the first and second electrodes comprise a first and a second electrode tab.

12. The assembly of claim 1, wherein the first electrode defines a boundary interval between the coated and uncoated portions having a length w3 that is equal to the width of the coated portion wherein an uncoated portion of the first electrode includes a first region that is attached to one of the coated portions substantially entirely along the length w3 and a second region that is attached to the first region that has a width that is shorter than the length w3.

13. A method of fabricating an electrode assembly for a rechargeable battery, the method comprising:
forming a first electrode plate having a first uncoated portion and a first coated portion that is coated with a first electrode material;
forming a second electrode plate having a second uncoated portion and a second coated portion that is coated with a second electrode material;
sizing the length of the boundary interval between the uncoated portion and the coated portion of the first electrode plate and the length of the boundary interval between the uncoated portion and the coated portion of the second electrode plate based upon the heat produced by the current flow through the boundary intervals in the first and second electrode plates so that the heat produced by the flow of current through the first boundary interval is reduced as a result of increasing the length of the first boundary interval; and
assembling the first electrode plate with the second electrode plate with a separator interposed therebetween.

14. A battery assembly comprising:
a first electrode plate having a first uncoated portion and a first coated portion that is coated with a first electrode material;
a second electrode plate having a second uncoated portion and a second coated portion that is coated with a second electrode material; and
a separator interposed between the first electrode plate and the second electrode plate; wherein a first length between the first uncoated portion and the first coated portion is greater than a second length between the second uncoated portion and the second coated portion; and
a case that receives the first electrode plate, the second electrode plate and the separator.

15. The assembly of claim 14, wherein the first electrode plate comprises a positive electrode plate and the second electrode plate comprises a negative electrode plate and wherein the first length comprises a length on the positive electrode plate and the second length comprises a length on the negative electrode plate.

16. The assembly of claim 14, wherein the first length is selected to be greater than the second length so that the heat produced by the first electrode plate is substantially the same as or less than the heat that is produced by the second electrode plate.

17. The assembly of claim 14, wherein the interval between the coated portion first active material and the non-coated portion of the first electrode plate comprises a first boundary interval having a width of w1 and wherein the interval between the coated portion second active material and the non-coated portion of the second electrode plate comprises a second boundary interval having a width of w2.

18. The assembly of claim 17, wherein the length of first boundary interval w1 is equal to or less than
$${w}_{1} = \sqrt{\frac{{R}_{1}}{{R}_{2}}} \cdot \frac{{d}_{2}}{{d}_{1}} {w}_{2}$$
wherein w2 comprises the length of the second boundary interval between the coated and the uncoated portions of the second electrode plate, R1 comprises the resistance of the coated portion of the first electrode, R2 comprises the resistance of the coated portion of the second electrode plate, d1 comprises the thickness of the first electrode plate and d2 comprises the thickness of the second electrode plate.

19. The assembly of claim 18, wherein the ratio of w1 to w2 falls within the range of approximately 1 to 11.39.

20. The assembly of claim 14, wherein a first boundary interval between the uncoated portion and the coated portion of the first electrode plate has a first length w1 and a second boundary interval between the uncoated portion material and the coated portion of the second electrode plate has a second length w2 and wherein the coated portions of the first and second electrode plates are aligned so as to be positioned adjacent each other along a line having a common length and wherein the sum of w1 and w2 is less than or equal to.
